(19) United States
(12) Patent Application Publication
(10) Pub. No.: US 2026/0352715 A1
(43) Pub. Date: Nov. 5, 2026

(54) SYSTEMS AND METHODS FOR REAL-TIME INTERNAL CONVERSATION

(71) Applicant: Genesys Cloud Services, Inc., Menlo Park, CA (US)

(72) Inventors: Rick G. Phung, Menlo Park, CA (US); Nicholas M. Robinson, Menlo Park, CA (US); Greg Boston, Carmel, IN (US); Bruna Marcolongo Schmitz, Galway (IE)

(21) Appl. No.: 19/255,845

(22) Filed: Jun. 30, 2025

Related U.S. Application Data
(60) Provisional application No. 63/798,346, filed on May 1, 2025.

(51) Int. Cl. H04L 65/1069; H04M 3/51

(52) U.S. Cl. CPC H04L 65/1069; H04M 3/51

(57) ABSTRACT

A method for enabling internal communication among agents of a contact center to facilitate a concurrent communication session with a customer with independent communication channels includes facilitating, by a computing system, a communication session between a customer device and a first agent device of an initial agent of a contact center via an initial communication channel. The method may further include establishing, by the computing system, communication between the first agent device of the initial agent and a second agent device of a secondary agent of the contact center via an internal communication channel that is independent of the initial communication channel between the customer device and the first agent device of the initial agent, to enable the initial agent to consult with the secondary agent with regard to the communication session contemporaneously with the communication session.

### CROSS-REFERENCE TO RELATED APPLICATIONS

This application claims priority to and the benefit of U.S. Provisional Application No. 63/798,346 titled “SYSTEMS AND METHODS FOR REAL-TIME INTERNAL CONVERSATION,” filed on May 1, 2025, the contents of which are incorporated herein by reference in their entirety.

### BACKGROUND

In a contact center, agents interact with clients to answer questions or perform operations on behalf of the clients, such as in support of one or more products offered by an organization. A client may communicate with an agent of the contact center via a communication channel, such as a voice communication channel or a text-based communication channel. In some instances, an agent may determine that it is necessary to communicate with another agent/supervisor or virtual assistant to provide improved support to the client. However, in conventional contact center systems, communication between agents for assistance with an ongoing communication with a client is limited or unavailable, due to technical limitations.

### SUMMARY

One embodiment is directed to a unique system, components, and methods for enabling real-time internal communication among agents of a contact center to facilitate a concurrent communication session with a customer. Other embodiments are directed to apparatuses, systems, devices, hardware, methods, and combinations thereof for enabling real-time internal communication among agents of a contact center to facilitate a concurrent communication session with a customer.

According to an embodiment, a method for enabling internal communication among agents of a contact center to facilitate a concurrent communication session with a customer with independent communication channels includes facilitating, by a computing system, a communication session between a customer device and a first agent device of an initial agent of a contact center via an initial communication channel. The method also includes establishing, by the computing system, communication between the first agent device of the initial agent and a second agent device of a secondary agent of the contact center via an internal communication channel that is independent of the initial communication channel between the customer device and the first agent device of the initial agent, to enable the initial agent to consult with the secondary agent with regard to the communication session contemporaneously with the communication session. The method may also include providing one or more communications from the initial communication channel to the second agent device of the secondary agent.

In some embodiments, facilitating the communication session via the initial communication channel includes transmitting communications between the customer device and the first agent device via the initial communication channel in which the initial communication channel is of a first media type. Further, establishing communication between the first agent device and the second agent device via the internal communication channel may comprise establishing the communication between the first agent device and the second agent device via the internal communication channel in which the internal communication channel is of a second media type, different from the first media type.

In some embodiments, providing one or more communications from the initial communication channel to the second agent device comprises providing a transcript of a concurrent voice communication between the first agent device and the customer device to the second agent device.

In some embodiments, the method may further include isolating communications between the first agent device and the second agent device via the internal communication channel from the customer device to prevent the customer from observing the communications between the first agent device and the second agent device.

In some embodiments, the method may further include providing a user interface that concurrently displays communications between the first agent device and the customer device transmitted via the initial communication channel and communications between the first agent device and the second agent device transmitted via the internal communication channel.

In some embodiments, the method may further include displaying the communications between the first agent device and the customer device in a first panel of the user interface and the communications between the first agent device and the second agent device in a second panel of the user interface.

In some embodiments, the method may further include providing a user interface with one or more user interface elements to search for the second agent prior to establishing communication between the first agent device and the second agent device.

In some embodiments, the method may further include providing a request from the first agent device to the second agent device to establish communication via the internal communication channel. Establishing communication via the internal communication channel may include establishing communication between the first agent device and the second agent device via the internal communication channel in response to receipt of an acceptance of the request.

In some embodiments, the method may further include providing one or more communications from the second agent device to the customer device via the initial communication channel after establishing communication between the first agent device and the second agent device via the internal communication channel.

In some embodiments, the method may further include transferring the communication session from the first agent device to the second agent device.

According to another embodiment, a system for enabling internal communication among agents of a contact center to facilitate a concurrent communication session with a customer with independent communication channels includes at least one processor and at least one memory. The memory may comprise a plurality of instructions stored thereon that, in response to execution by the at least one processor, causes the system to facilitate a communication session between a customer device and a first agent device of an initial agent of a contact center via an initial communication channel. The instructions may further cause the system to establish communication between the first agent device of the initial agent and a second agent device of a secondary agent of the contact center via an internal communication channel that is independent of the initial communication channel between the customer device and the first agent device of the initial agent, to enable the initial agent to consult with the secondary agent with regard to the communication session contemporaneously with the communication session. To establish communication may include to provide one or more communications from the initial communication channel to the second agent device of the secondary agent.

In some embodiments, to facilitate the communication session via the initial communication channel may include to transmit communications between the customer device and the first agent device via the initial communication channel in which the initial communication channel is of a first media type. Further, to establish communication between the first agent device and the second agent device via the internal communication channel may include to establish the communication between the first agent device and the second agent device via the internal communication channel in which the internal communication channel is of a second media type, different from the first media type.

In some embodiments, to provide one or more communications from the initial communication channel to the second agent device may include to provide a transcript of a concurrent voice communication between the first agent device and the customer device to the second agent device.

In some embodiments, the plurality of instructions may further cause the system to isolate communications between the first agent device and the second agent device via the internal communication channel from the customer device to prevent the customer from observing the communications between the first agent device and the second agent device.

In some embodiments, the plurality of instructions may further cause the system to provide a user interface that concurrently displays communications between the first agent device and the customer device transmitted via the initial communication channel and communications between the first agent device and the second agent device transmitted via the internal communication channel.

In some embodiments, the plurality of instructions may further cause the system to display the communications between the first agent device and the customer device in a first panel of the user interface and the communications between the first agent device and the second agent device in a second panel of the user interface.

In some embodiments, the plurality of instructions may further cause the system to provide a user interface with one or more user interface elements to search for the second agent prior to establishing communication between the first agent device and the second agent device.

In some embodiments, the plurality of instructions may further cause the system to provide a request from the first agent device to the second agent device to establish communication via the internal communication channel. Further, to establish communication via the internal communication channel may include to establish communication between the first agent device and the second agent device via the internal communication channel in response to receipt of an acceptance of the request.

In some embodiments, the plurality of instructions may further cause the system to provide one or more communications from the second agent device to the customer device via the initial communication channel after establishing communication between the first agent device and the second agent device via the internal communication channel.

In some embodiments, the plurality of instructions may further cause the system to transfer the communication session from the first agent device to the second agent device.

In accordance with an embodiment of the present disclosure, a method for managing interactions is provided. For example, the method may include receiving a request from a first agent for an internal conversation, in response to receiving an input from a second agent to proceed with the internal conversation with the first agent, providing a first panel and a second panel, the first panel including an active conversation between the first agent and a customer and being updated in near real-time, and the second panel including an internal conversation between the first agent and the second agent, and allowing the second agent to access and monitor the active conversation between the first agent and the customer in near real-time.

In accordance with an embodiment of the present disclosure, the method may include where the active conversation is in a first media type and the internal conversation is in a second media type that is different from the first media type.

In accordance with an embodiment of the present disclosure, the method may include where the media type is voice, text, email, chat, SMS, social media, etc.

In accordance with an embodiment of the present disclosure, the method may include where the first panel and the second panel are provided in a same window side-by-side, and the window including a list of conversations that the second agent have access to.

In accordance with an embodiment of the present disclosure, the method may further include transferring the active conversation to the second agent, or allowing the second agent to directly interact with the customer in the first panel.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIGS. 3-5 are a simplified flow diagram of at least one embodiment of a method of enabling internal communication among agents of a contact center to facilitate a concurrent communication session with a customer; and

FIG. 6-17 are diagrams of user interfaces that may be produced by the contact center system to enable internal communication among agents to facilitate a concurrent communication session with a customer.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The technologies described herein pertain to contact centers and associated cloud-based systems. More particularly, the technologies described herein relate to enabling an agent (an “initial agent”) to communicate with one or more other agents (“secondary agents”) of a contact center system regarding a communication session with a customer as the communication session with the customer is taking place (e.g., in real-time). As described in more detail herein, the technologies enable the initial agent to communicate with the other secondary agents via an internal communication channel that is independent of the communication channel through which the initial agent is communicating with the customer, in that any communications between the initial agent and the secondary agent(s) are not shared with the customer and the internal communication channel may be of a different media type (e.g., text) than the media type of the communication channel between the initial agent and the customer (e.g., voice). Further, and as described herein, the technologies enable communications from the communication session with the customer to be shared via the internal communication channel with the one or more secondary agents to enable the one or more secondary agents to understand the context of the communication session and the assistance needed to provide support to the customer. Additionally, the technologies described herein enable the secondary agent(s) to communicate with the customer to provide the support. In some embodiments, the communication session may be transferred from the initial agent to a secondary agent to continue the communication session with the customer. In some embodiments, the secondary agent (e.g., supervisor) is able to use internal messaging to coach the agent while monitoring the agent’s interaction with the customer.

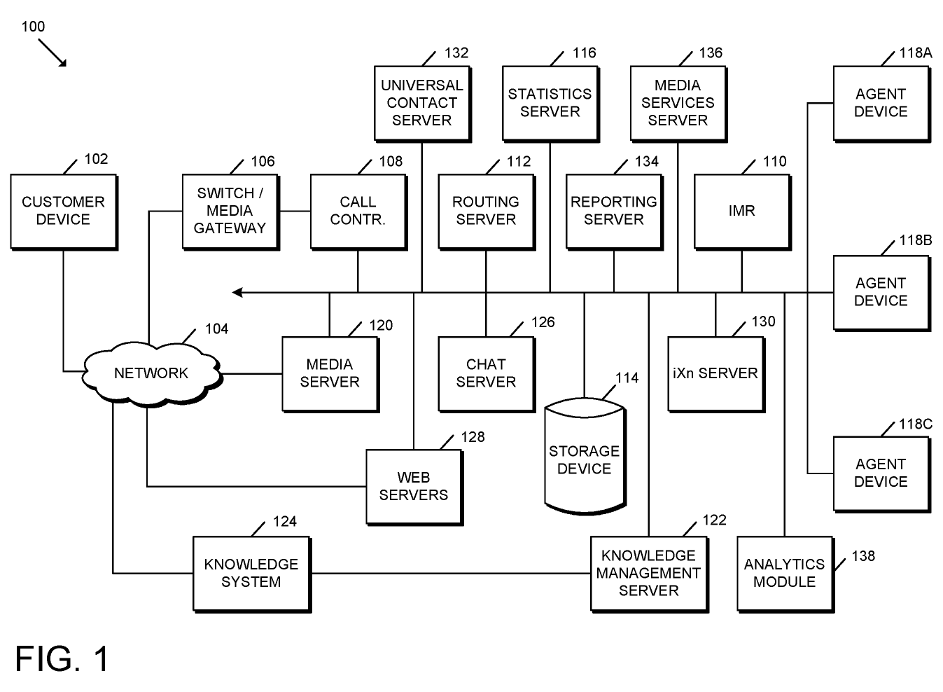

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to a customer and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

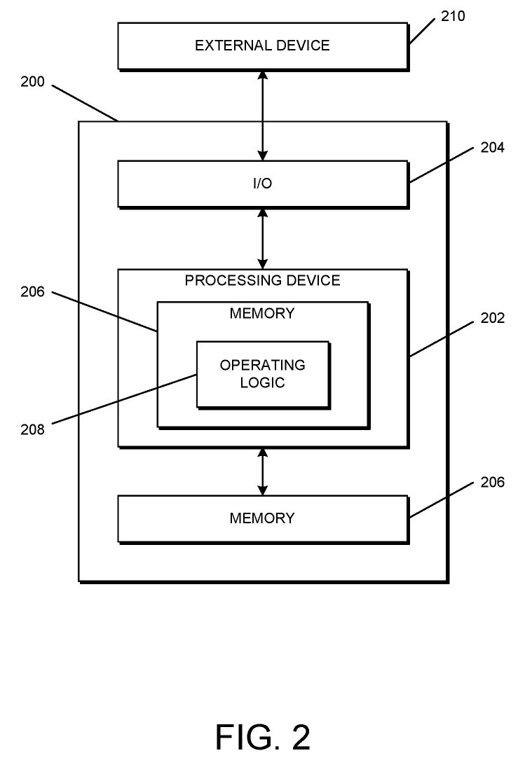

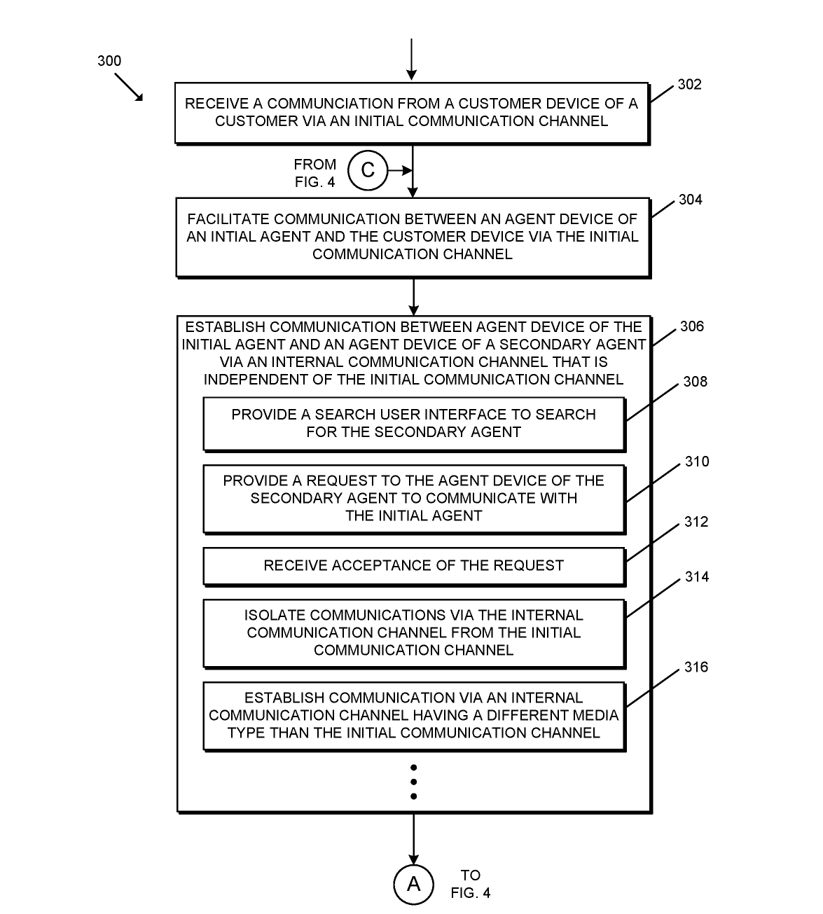

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer’s telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

In today's customer experience landscape, businesses are expected to engage with customers across a wide range of communication channels, including voice and text-based channels. Customers demand seamless, timely, and consistent service regardless of the channel they choose. To meet this expectation, contact center agents require flexible tools that empower them to respond effectively and efficiently. However, most current contact center solutions remain constrained by the interaction channel initiated by the customer. For example, when a customer initiates a voice call, the agent handling the inquiry is often restricted to voice-only communication even when internal consultation with another agent or supervisor is necessary (a secondary agent). This channel-dependent limitation prevents agents from leveraging alternative modalities such as chat, SMS, or collaboration tools to consult internally, leading to inefficiencies and delays in customer resolution.

Additionally, in today’s highly digital and customer-centric environment, rapid and effective communication is essential to delivering successful customer engagements. However, it is not uncommon for an agent, after accepting an interaction, to determine that the agent is unable to resolve the issue independently. Such as situation may arise due to the complexity of the inquiry, the need for domain-specific expertise, or workload constraints.

As described herein, embodiments of a computing system (e.g., the contact center system 100, the computing device 200, and/or other computing devices described herein) enable agents to initiate real-time consultations with peers or supervisors, regardless of the channel used for the original customer interaction, be it voice-based, text-based, or otherwise. Embodiments of the computing system allow for seamless handoff of the interaction to the consulted party, once context has been provided, without disrupting the customer experience. By enabling in-channel or cross-channel consultation and transfer, this capability enhances operational agility, reduces customer wait times, improves overall service quality, and increases first contact resolution. Further, embodiments of the computing system facilitate more intelligent routing of interactions based on agent expertise, optimizing workforce utilization, and ultimately delivering a more responsive and connected customer experience.

In accordance with an embodiment of the present disclosure, the computing system is configured to allow an agent to consult with other agents, supervisor, or AI bot using an internal messaging digital channel regardless of which interaction channel is being used with a customer. To do so, the computing system may establish a new internal communication channel to allow the agent to communicate other agents, supervisors, or AI bot (secondary agent(s)). Once the new internal communication channel is established, the invited agents, supervisors, or AI bot (secondary agent(s)) can view the conversation between the agent and the customer. Embodiments of the computing system allow the agent to transfer the customer, even for voice calls, to the consulted agent or supervisor (secondary agent) when required. Additionally, embodiments of the computing system ensure that such activity is accurately reflected in a contact center operation report and interaction details. The content of the internal communication is not visible to the customer.

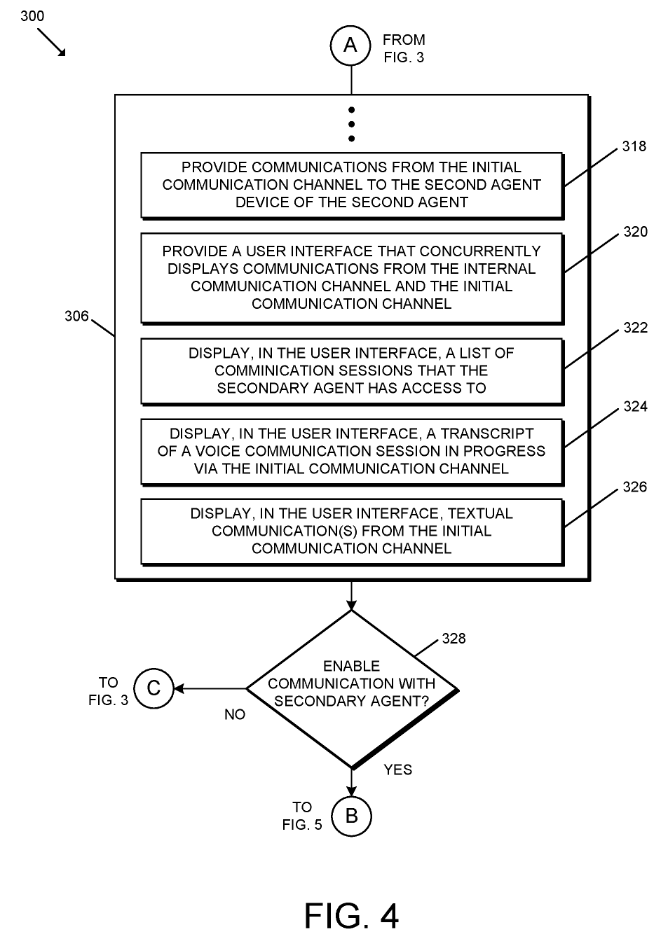

Referring now to FIG. 3, in use, a computing system (e.g., the contact center system 100, one or more computing devices 200, and/or other computing devices described herein) may execute a method 300 for enabling internal communication among agents of a contact center to facilitate a concurrent communication session with a customer. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302, in which the computing system receives a communication from a customer device (e.g., customer device 102) of a customer via an initial communication channel. The initial communication channel may be, for example, a voice communication channel, video communication channel, a text-based communication channel (e.g., email, text messages, etc.), or otherwise. As such, the initial communication channel has a media type (e.g., voice, video, email, text messages, etc.) related to the format of the communications transmitted via the initial communication channel. Continuing the method 300, in block 304, the computing system facilitates communication between an agent device (e.g., an agent device 118A, 118B, 118C) of an initial agent and the customer device 102 of the customer via the initial communication channel. The initial agent, in the illustrative embodiment, is any agent who initially is assigned to and receives the communication from the customer device 102. In facilitating communication, the computing system may transmit communications from the customer device 102 to the agent device 118 and, similarly, may transmit communications from the agent device 118 to the customer device 102. The communications transmitted to and from the customer device 102 an the agent device 118 are of the media type (e.g., voice, video, text, etc.) associated with the initial communication channel.

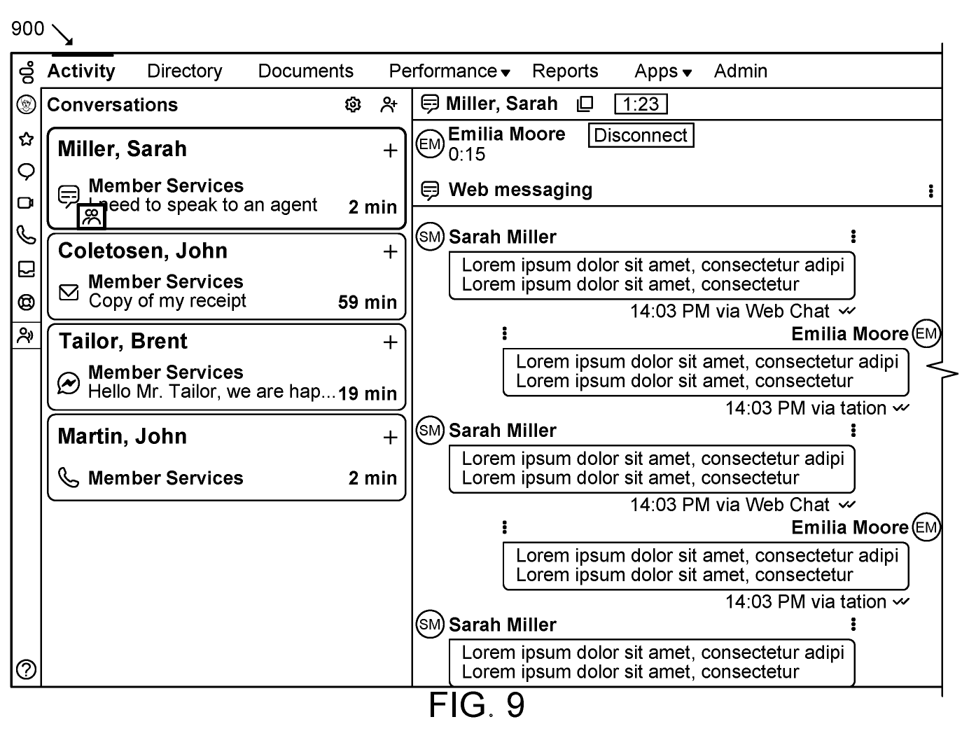

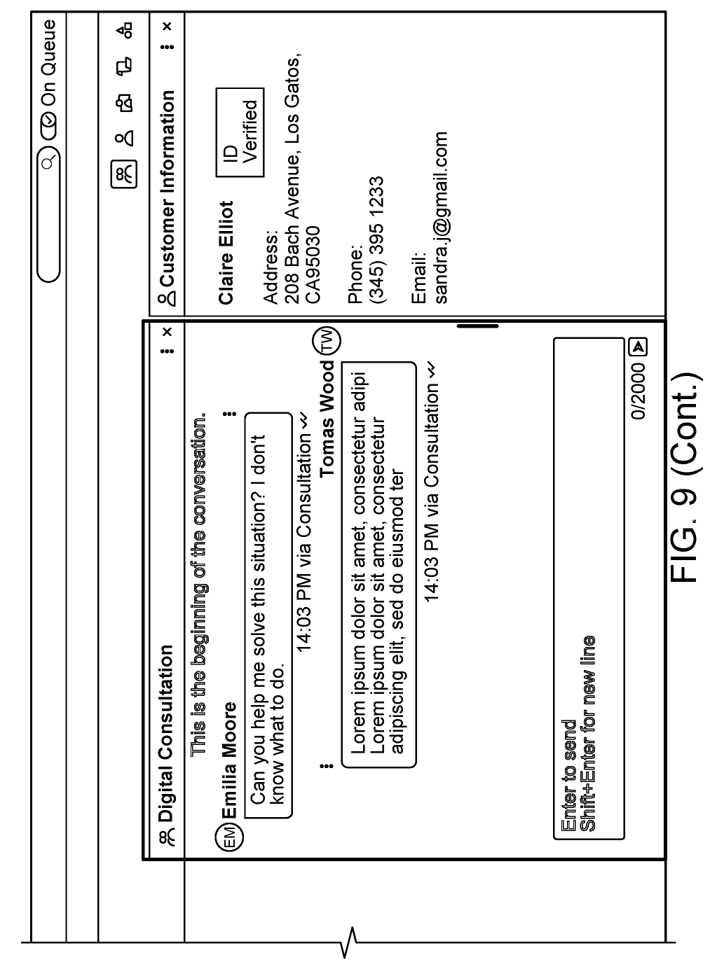

Continuing the method 300, in block 306, the computing system may establish communication between the agent device 118 of the initial agent and an agent device 118 of another agent (a “secondary agent”) via an internal communication channel that is independent of the initial communication channel. The computing system may do so, for example, to enable the initial agent to consult with a secondary agent, regarding the ongoing communication session with the customer. For example, the initial agent may determine that the question is outside of the expertise of the initial agent or that the initial agent does not have available capacity (e.g., time) to provide the support that the initial agent determines is necessary to resolve a question or request from the customer. The secondary agent may be, for example, a colleague who also works as an agent of the contact center system 100, a supervisor of the initial agent, or an automated agent (e.g., a bot). In block 308, The computing system may provide a user interface with one or more user interface elements to enable the initial agent to search for a secondary agent with which to communicate via the internal communication channel. An embodiment of a user interface 600 with a panel 610 for such search functionality is illustrated in FIG. 6. Once the connection is established between the initial agent and the secondary agent, an interaction discussion panel appears next to an existing digital interaction panel with the customer, as shown in FIG. 9.

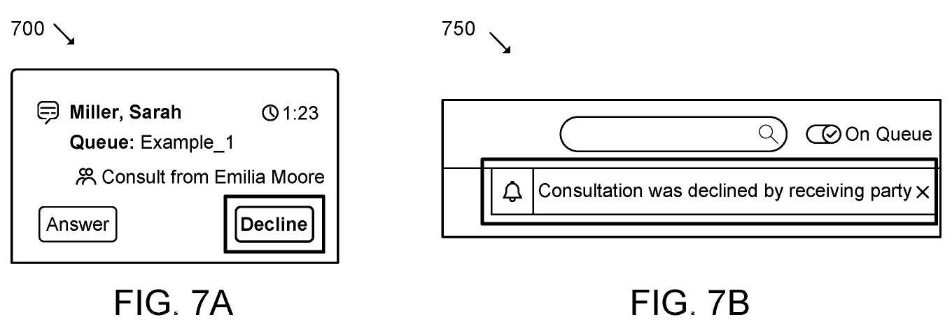

As indicated in block 310, the computing system may provide a request to the agent device 118 of the secondary agent (e.g., identified from a search operation associated with block 308) to communicate with the initial agent with regard to the ongoing communication session with the customer. Further, in block 312, the computing system may receive an acceptance of the request from the secondary agent. That is, the computing system may receive, from an agent device 118 of the secondary agent, data representative of an acceptance of the request. The data may be produced by the agent device 118 of the secondary agent in response to a corresponding interaction with a user interface presented to the secondary agent. In some embodiments, the computing system may receive a denial (e.g., data indicative of a denial) of the request from the secondary agent (e.g., from the agent device 118 of the secondary agent), in which case the initial agent may search for and request that another secondary agent communicate with the initial agent via the internal communication channel. Referring briefly to FIG. 7A, the computing system may provide user interface 700, to an agent device 118 to which a request is submitted, enabling the secondary agent to answer (e.g., accept) or decline (e.g., deny) the request to communicate with the initial agent regarding the ongoing communication session with the customer. FIG. 7B illustrates an embodiment of a user interface 750 that may be provided by the computing system to inform the initial agent that the secondary agent declined the request. Regardless, in establishing communication between the agent device 118 of the initial agent and an agent device 118 of a secondary agent, the computing system, in the illustrative embodiment, isolates any communications transmitted via the internal communication channel from the initial communication channel, in block 314. That is, the computing system prevents any communications sent between the initial agent and the secondary agent via the internal communication channel from being shared with the customer device 102 via the initial communication channel. Further, in establishing the communication between the agent device 118 of the initial agent and the agent device 118 of the secondary agent, the computing system may establish communication via an internal communication channel that has a different media type than the initial communication channel, as indicated in block 316. For example, while the media type of the initial communication channel may be voice, the media type of the internal communication channel be text or another type of media.

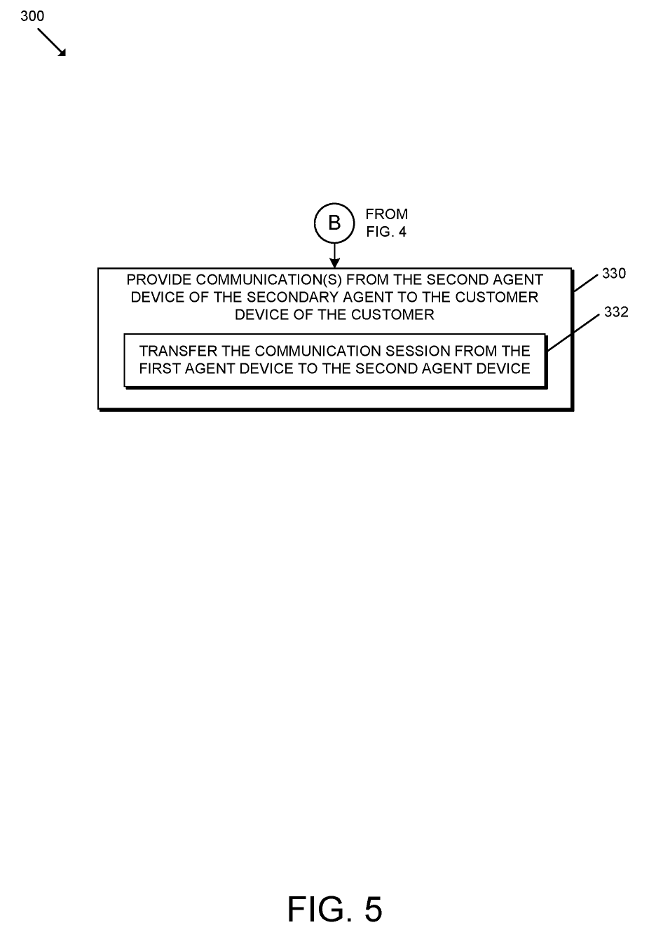

Continuing the method 300, in block 318 of FIG. 4, the computing system may provide one or more communications from the initial communication channel to the agent device 118 of the secondary agent. Doing so enables the secondary agent to determine the context of the request from the customer, evaluate the progress of the communication session, and determine what additional support should be provided to assist with the request from the customer. As indicated in block 320, the computing system may provide a user interface that concurrently displays communication from the internal communication channel, between the agent device 118 of the initial agent and the agent device 118 of the secondary agent, and communications from the initial communication channel (e.g., the communication channel between the agent device 118 of the initial agent and the customer device 102 of the customer). The computing system may cause the user interface to be displayed by the agent device 118 of the initial agent and/or the agent device 118 of the secondary agent.

The computing system may display, in the user interface, a list of communication sessions that the secondary agent has access to, as indicated in block 322. That is, in at least some embodiments, the agent device 118 of the secondary agent may display a list of communication sessions that secondary agent is associated with and may update the user interface to display communications associated with a selected communication session in response to selection of the corresponding communication from the list. In block 324, the computing system may display, in the user interface, a transcript of a voice communication session that is in progress via the initial communication channel. That is, while the internal communication channel may be text based and the user interface may be configured to display textual communications associated with a communication session, the computing system may convert voice-based communications taking place between the initial agent and the customer via the initial communication channel to text (e.g., as a transcript) and provide the resulting text (the transcript) to the agent device 118 of the secondary agent for display in a corresponding user interface as the communication session takes place. Alternatively, such as if the communication session between the initial agent and the customer is text based, rather than voice based, the computing system may display, in the user interface, textual communications from the initial communication channel, as indicated in block 326.

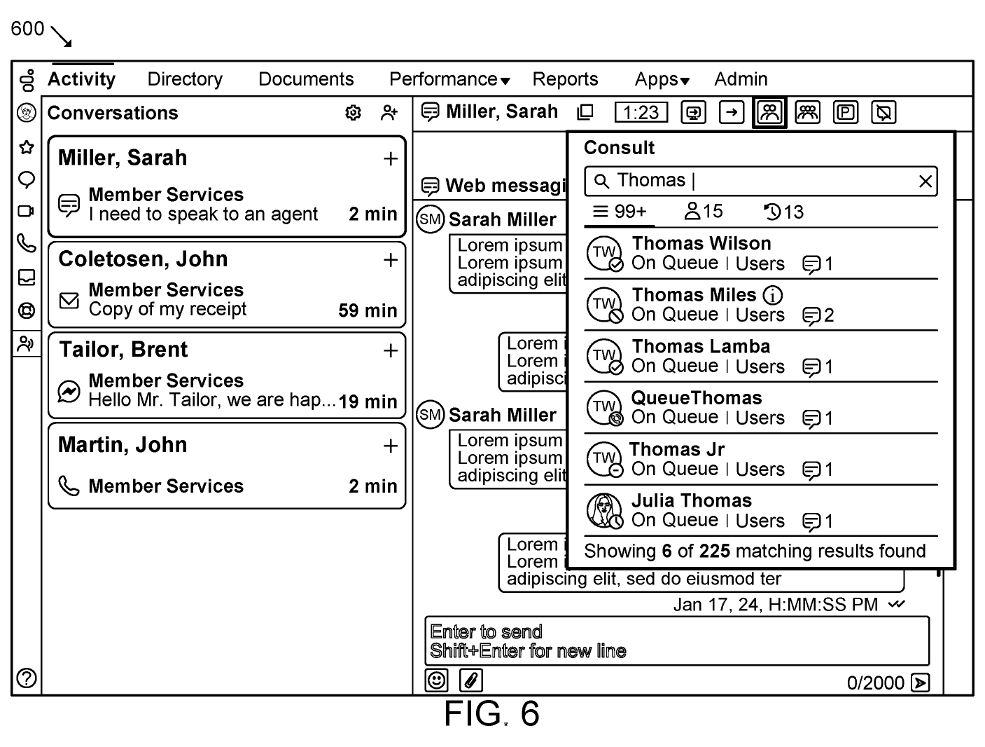

In block 328, the computing system may determine whether to enable direct communication between the agent device 118 of the secondary agent and the customer device 102. The computing system may determine to enable direct communication for different reasons, depending on the embodiment, such as if the initial agent requests or approves direct communication between the secondary agent and the customer and/or if the secondary agent agrees to communicate directly with the customer. Regardless, in response to a determination to enable communication between the customer and the secondary agent, the method 300 advances to block 330 of FIG. 5, described herein. Otherwise, the method 300 returns to block 304 of FIG. 3 in which the computing system continues to facilitate communication between the agent device 118 of the initial agent and the customer device 102. In response to a determination to enable the agent device 118 of the secondary agent to communicate with the customer device 102 of the customer, in block 330 of FIG. 5, the computing system provides one or more communications from the agent device 118 of the secondary agent to the customer device 102 of the customer, via the initial communication channel. In doing so, in at least some embodiments, the computing system may transfer (e.g., reassign) the communication session to the secondary agent, in block 332.

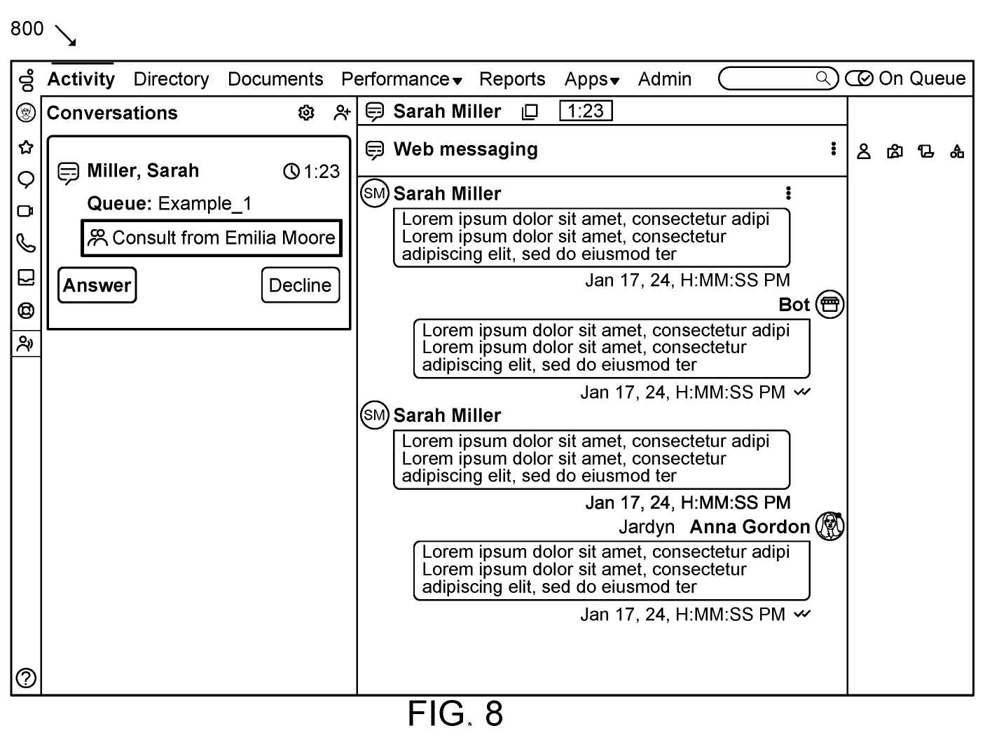

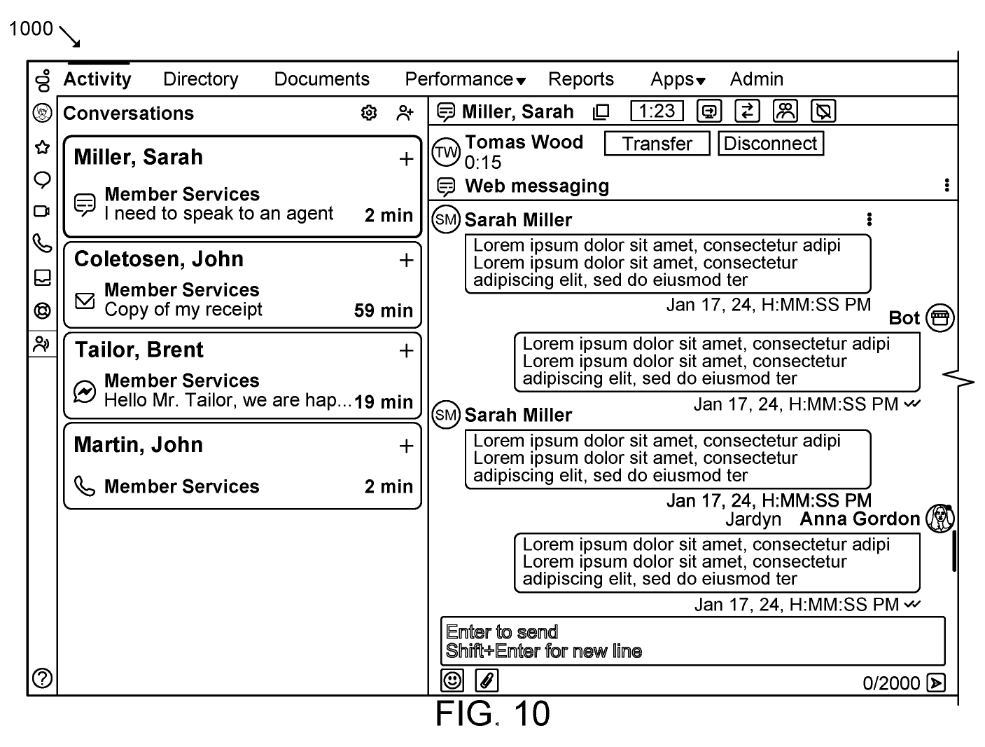

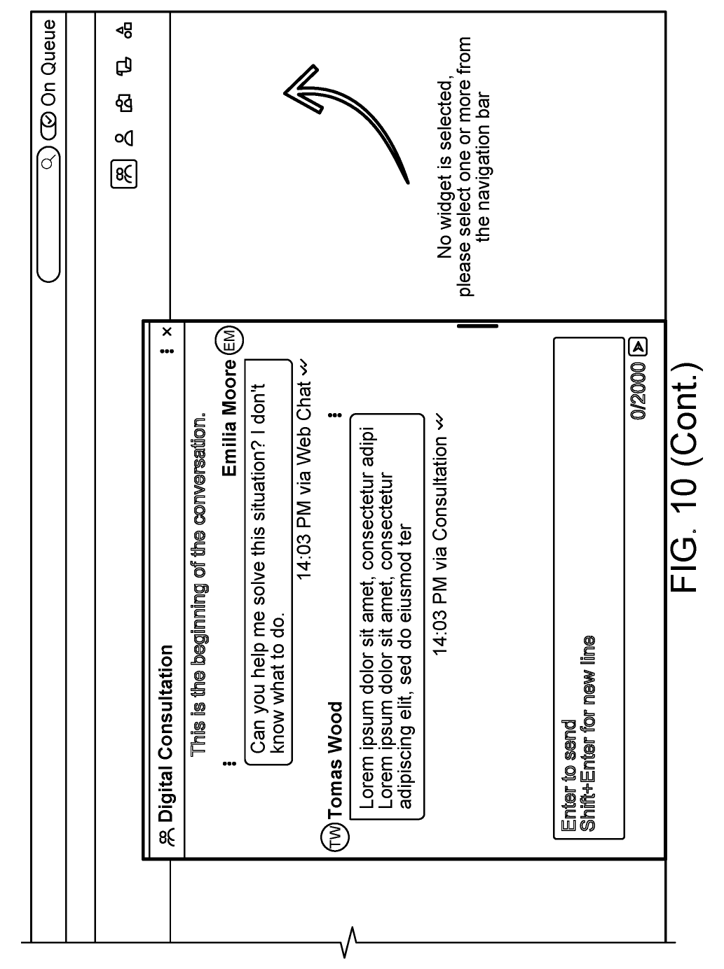

FIG. 8 illustrates a user interface 800 that may be presented to the secondary agent when the secondary agent receives a consultation request from the initial agent. The secondary agent is alerted of the consultation request, and the secondary agent has an option to accept/answer or decline the consultation request. The secondary agent can accept the consultation request by clicking on the designated icon or button (e.g., “Answer” icon) 810 to be connected to the initial agent who initiated the discussion. Upon accepting the consultation request, an interaction discussion panel appears and is available for both the initial agent as shown in the user interface 1000 of FIG. 10 and the secondary agent, as shown in the user interface 900 of FIG. 9 to begin discussion. That is, FIG. 9 illustrates a user interface 900 that may be presented to the secondary agent while having an internal discussion with the initial agent. A panel 910 represents the communications between the initial agent and the secondary agent. As can be seen in FIG. 9, the secondary agent can view an interaction between the initial agent and the customer in another panel 920. Further, a list of conversations 930 that the user (e.g., the secondary agent) has access to is displayed. FIG. 10 illustrative a user interface 1000 that may be presented to the initial agent while having an internal discussion with the secondary agent.

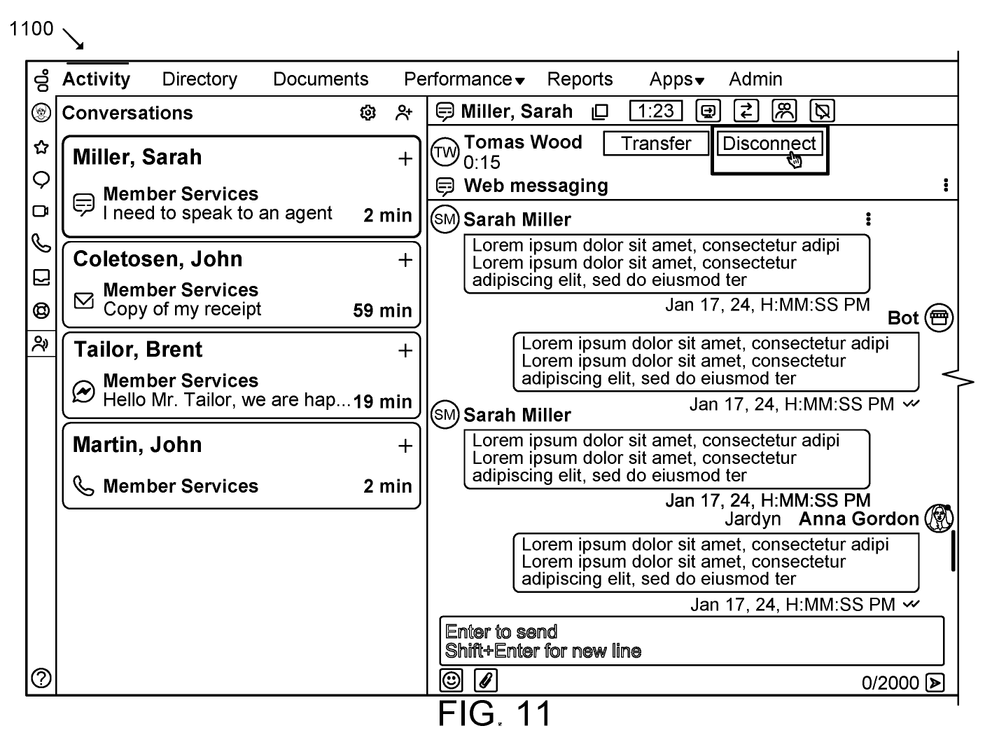

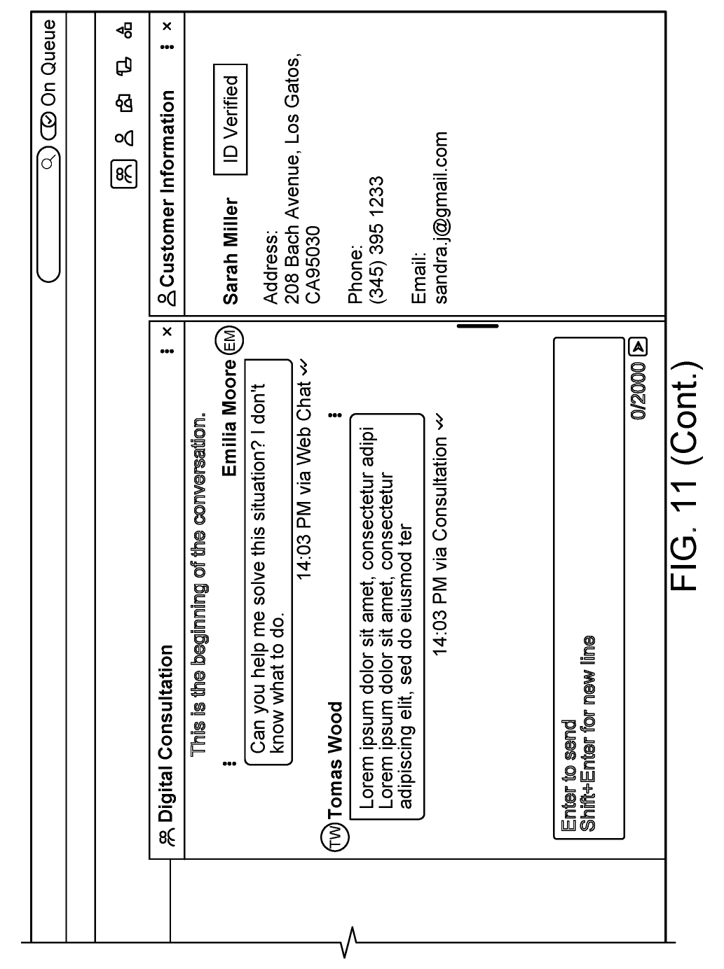

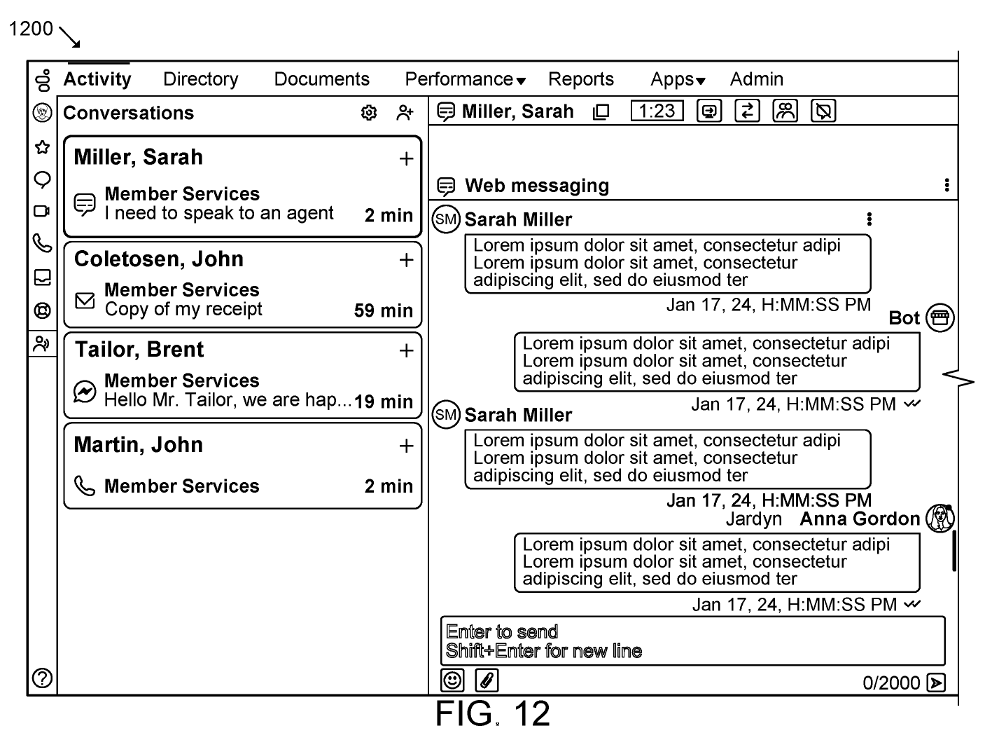

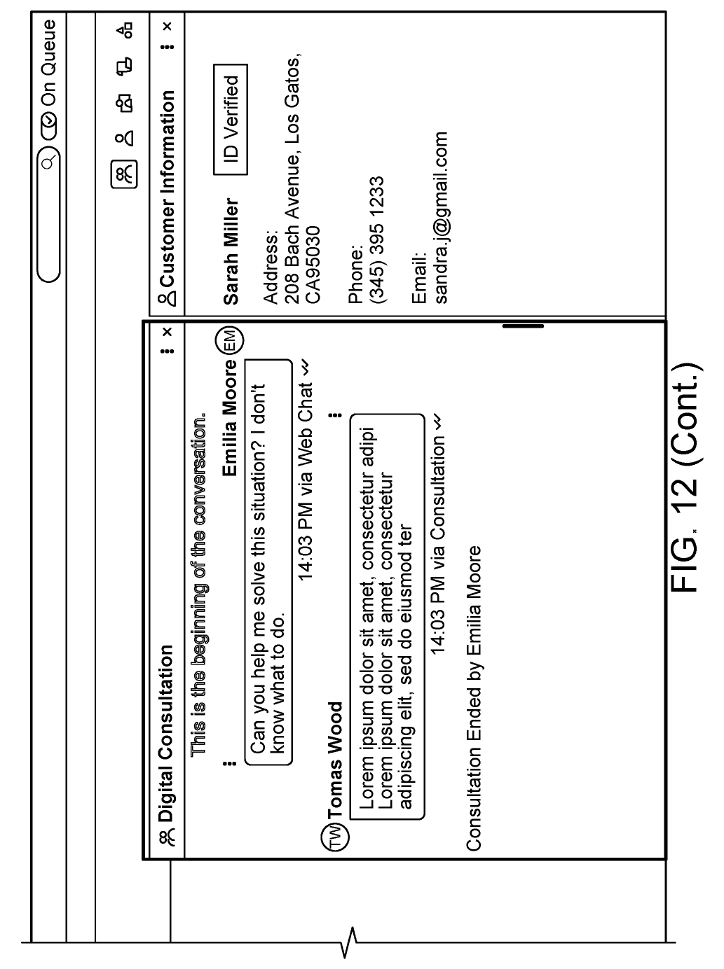

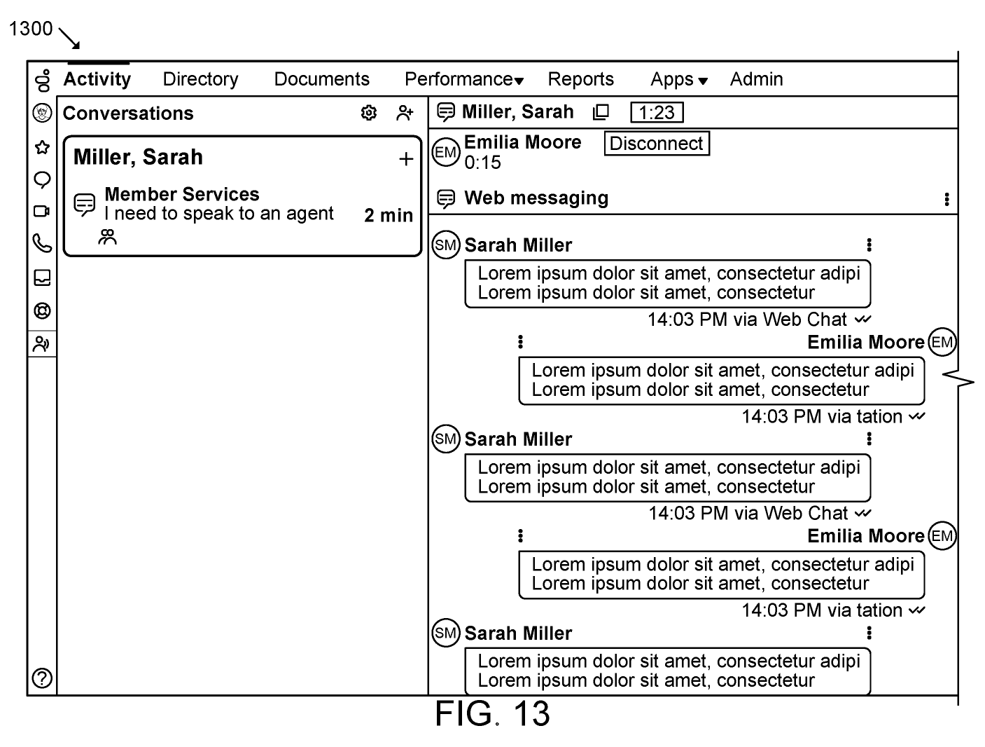

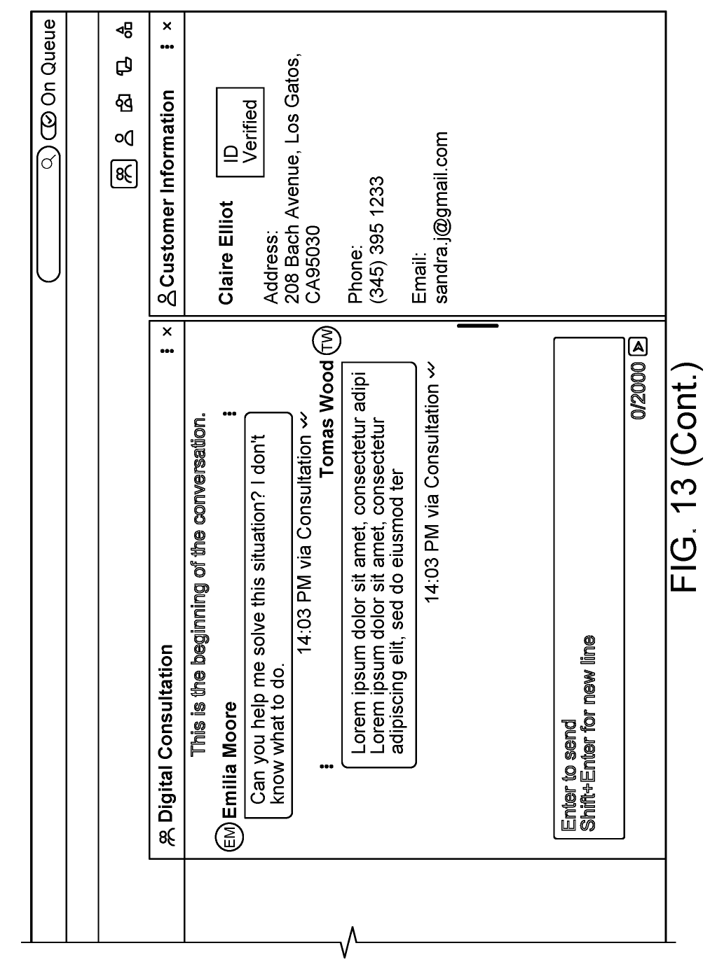

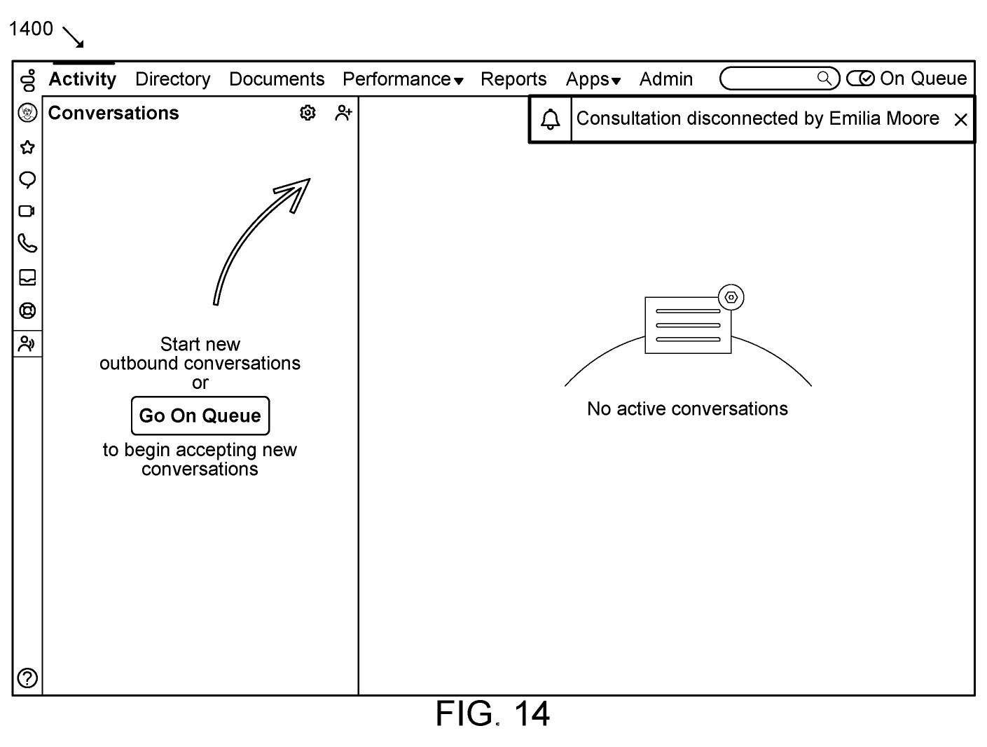

FIGS. 11-14 show exemplary user interfaces 1100, 1200, 1300, 1400 that may be presented by the computing system before and after a consultation session between the initial agent and the secondary agent. More specifically, the user interfaces 1100, 1200 of FIGS. 11 and 12 may be presented to the initial agent and the user interfaces 1300, 1400 may be presented to the secondary agent.

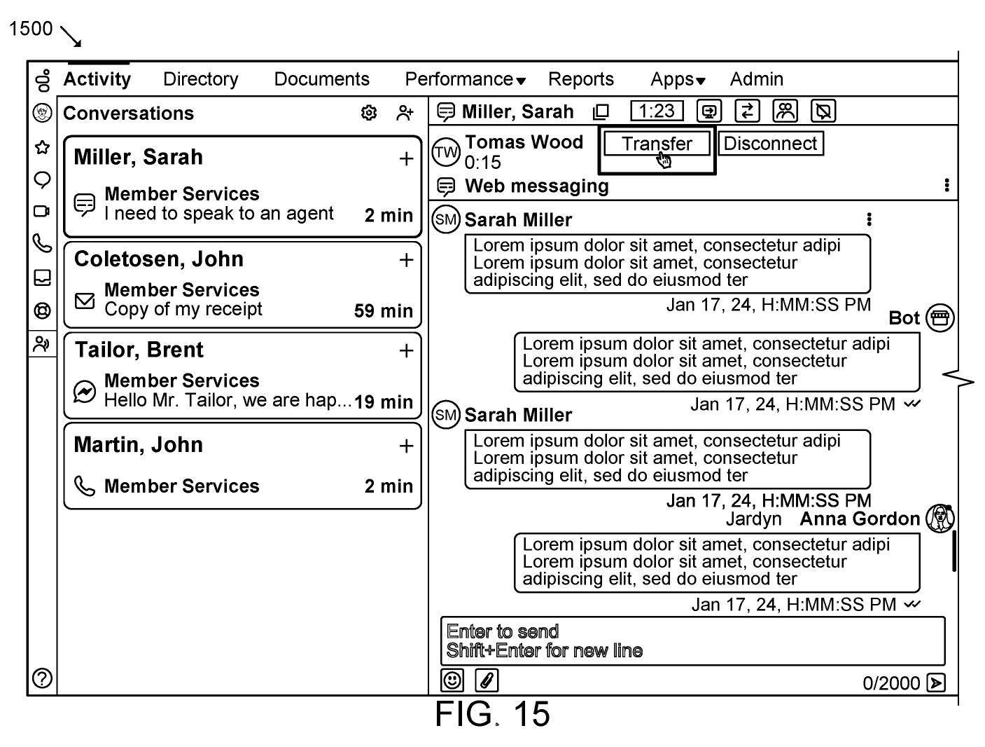

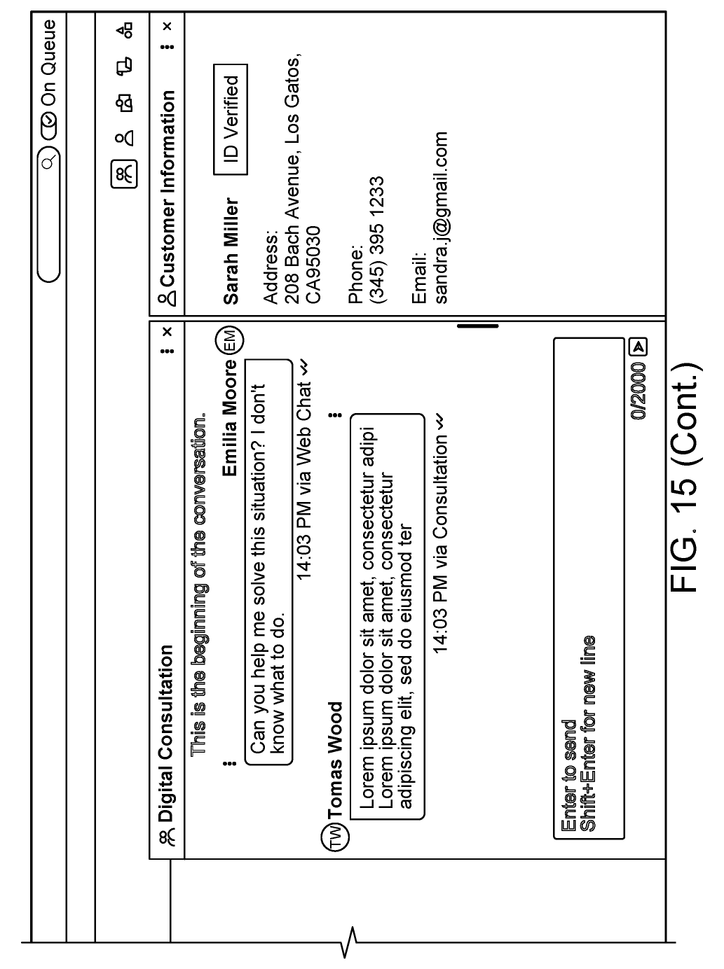

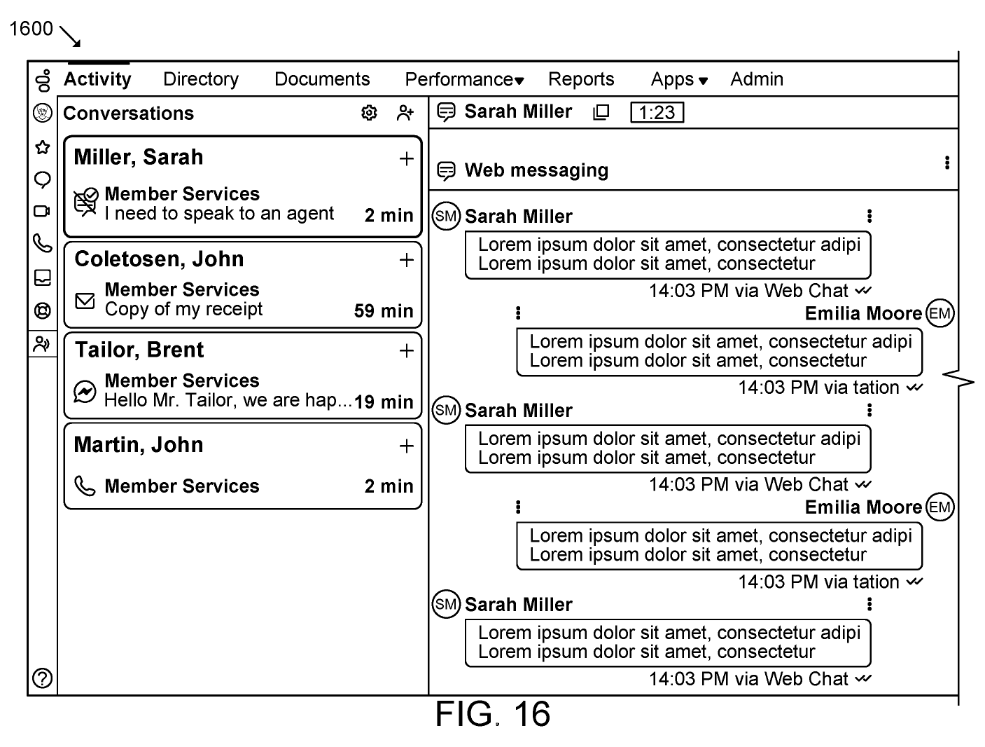

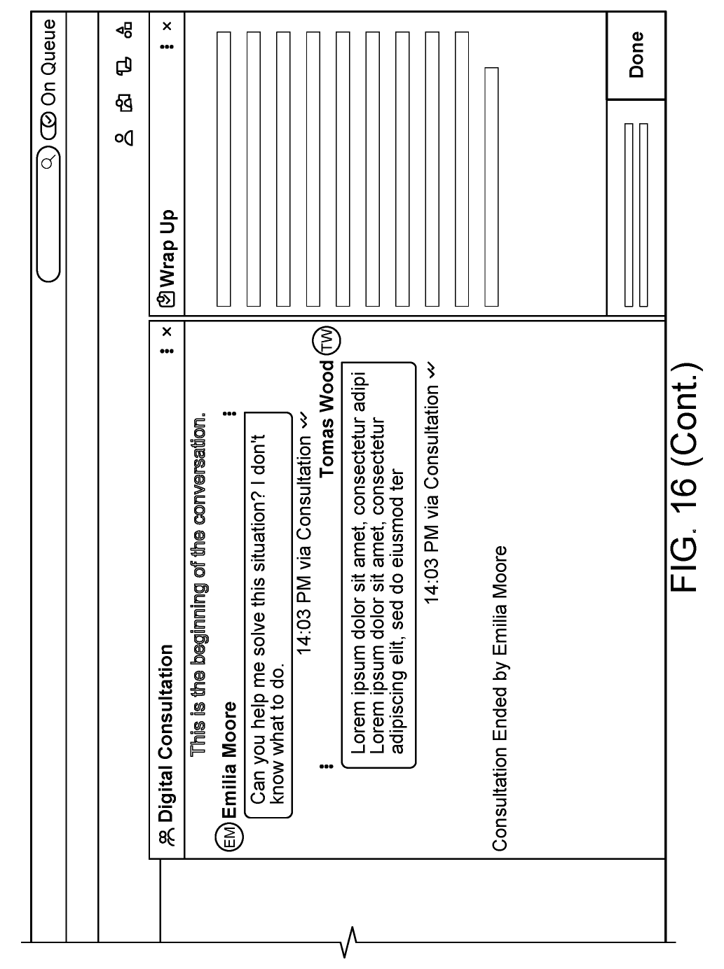

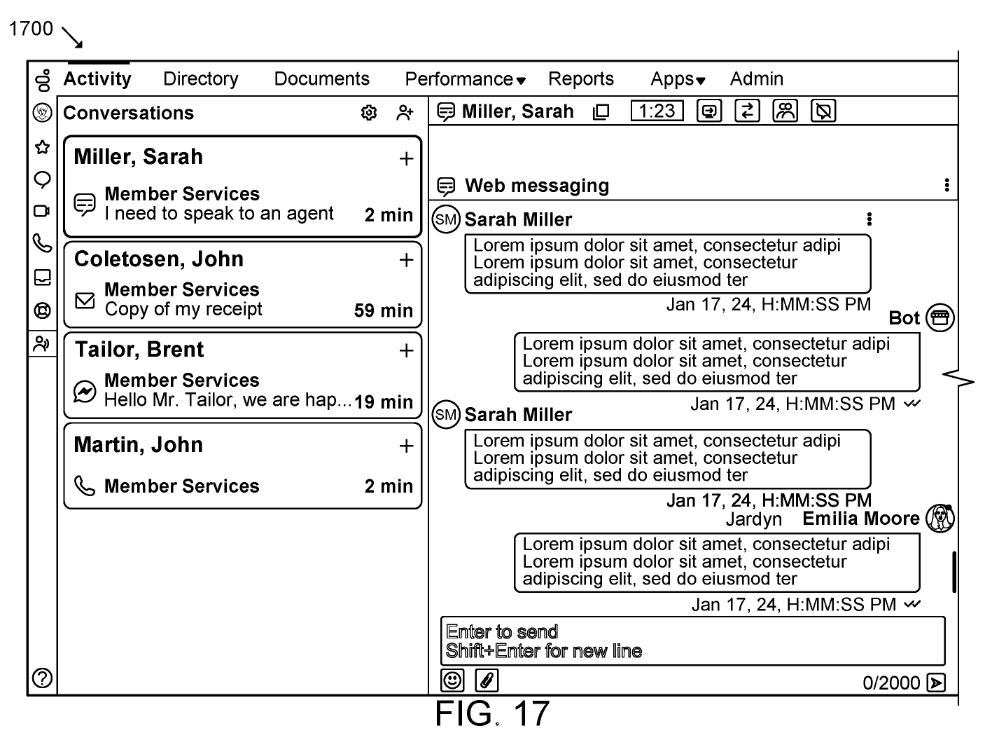

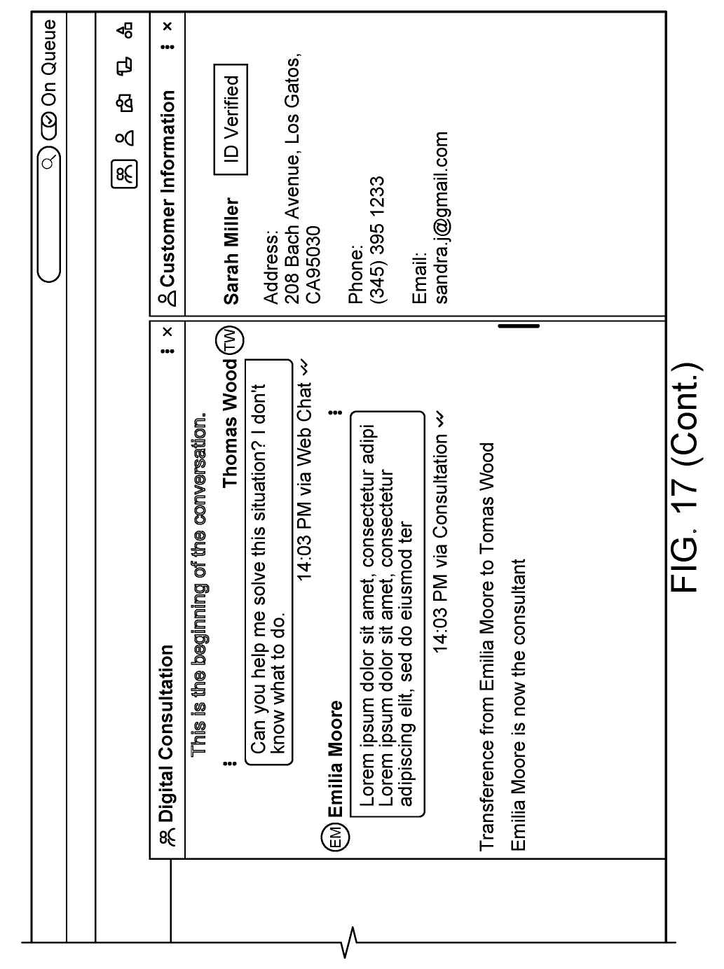

FIGS. 15-17 show exemplary user interfaces 1500, 1600, 1700 that may be presented by the computing system when an active communication session between the initial agent and the customer is transferred to the secondary agent to enable the secondary agent to directly interact with the customer. In particular, the computing device may present the user interfaces 1500, 1600 to the initial agent and may present the user interface 1700 to the secondary interface.

Although the various user interface panels are depicted herein in particular orientations, it should be appreciated the panels may be otherwise positioned and/or have varied functionality in other embodiments. For example, in some embodiments, the panels can be positioned in another orientation other than side-by-side and/or may be repositioned by agent according to their preferences. Further, in some embodiments, a particular panel may remain open for future reference, even when the conversation has disconnected. In another embodiment, a blocking mechanism may prevent agents prove having access to both conversations at the same time.

What is claimed is:

1. A method for enabling internal communication among agents of a contact center to facilitate a concurrent communication session with a customer with independent communication channels, the method comprising:
facilitating, by a computing system, a communication session between a customer device and a first agent device of an initial agent of a contact center via an initial communication channel; and
establishing, by the computing system, communication between the first agent device of the initial agent and a second agent device of a secondary agent of the contact center via an internal communication channel that is independent of the initial communication channel between the customer device and the first agent device of the initial agent, to enable the initial agent to consult with the secondary agent with regard to the communication session contemporaneously with the communication session, including providing one or more communications from the initial communication channel to the second agent device of the secondary agent.

2. The method of claim 1, wherein facilitating the communication session via the initial communication channel comprises transmitting communications between the customer device and the first agent device via the initial communication channel in which the initial communication channel is of a first media type; and
establishing communication between the first agent device and the second agent device via the internal communication channel comprises establishing the communication between the first agent device and the second agent device via the internal communication channel in which the internal communication channel is of a second media type, different from the first media type.

3. The method of claim 1, wherein providing one or more communications from the initial communication channel to the second agent device comprises providing a transcript of a concurrent voice communication between the first agent device and the customer device to the second agent device.

4. The method of claim 1, further comprising isolating communications between the first agent device and the second agent device via the internal communication channel from the customer device to prevent the customer from observing the communications between the first agent device and the second agent device.

5. The method of claim 1, further comprising providing a user interface that concurrently displays communications between the first agent device and the customer device transmitted via the initial communication channel and communications between the first agent device and the second agent device transmitted via the internal communication channel.

6. The method of claim 5, further comprising displaying the communications between the first agent device and the customer device in a first panel of the user interface and the communications between the first agent device and the second agent device in a second panel of the user interface.

7. The method of claim 1, further comprising providing a user interface with one or more user interface elements to search for the second agent prior to establishing communication between the first agent device and the second agent device.

8. The method of claim 1, further comprising:
providing a request from the first agent device to the second agent device to establish communication via the internal communication channel;
wherein establishing communication via the internal communication channel comprises establishing communication between the first agent device and the second agent device via the internal communication channel in response to receipt of an acceptance of the request.

9. The method of claim 1, further comprising providing one or more communications from the second agent device to the customer device via the initial communication channel after establishing communication between the first agent device and the second agent device via the internal communication channel.

10. The method of claim 9, further comprising transferring the communication session from the first agent device to the second agent device.

11. A system for enabling internal communication among agents of a contact center to facilitate a concurrent communication session with a customer with independent communication channels, the system comprising:
at least one processor; and
at least one memory comprising a plurality of instructions stored thereon that, in response to execution by the at least one processor, causes the system to:
facilitate a communication session between a customer device and a first agent device of an initial agent of a contact center via an initial communication channel; and
establish communication between the first agent device of the initial agent and a second agent device of a secondary agent of the contact center via an internal communication channel that is independent of the initial communication channel between the customer device and the first agent device of the initial agent, to enable the initial agent to consult with the secondary agent with regard to the communication session contemporaneously with the communication session, wherein to establish communication includes to provide one or more communications from the initial communication channel to the second agent device of the secondary agent.

12. The system of claim 11, wherein to facilitate the communication session via the initial communication channel comprises to transmit communications between the customer device and the first agent device via the initial communication channel in which the initial communication channel is of a first media type; and
wherein to establish communication between the first agent device and the second agent device via the internal communication channel comprises to establish the communication between the first agent device and the second agent device via the internal communication channel in which the internal communication channel is of a second media type, different from the first media type.

13. The system of claim 11, wherein to provide one or more communications from the initial communication channel to the second agent device comprises to provide a transcript of a concurrent voice communication between the first agent device and the customer device to the second agent device.

14. The system of claim 11, wherein the plurality of instructions further causes the system to isolate communications between the first agent device and the second agent device via the internal communication channel from the customer device to prevent the customer from observing the communications between the first agent device and the second agent device.

15. The system of claim 11, wherein the plurality of instructions further causes the system to provide a user interface that concurrently displays communications between the first agent device and the customer device transmitted via the initial communication channel and communications between the first agent device and the second agent device transmitted via the internal communication channel.

16. The system of claim 15, wherein the plurality of instructions further causes the system to display the communications between the first agent device and the customer device in a first panel of the user interface and the communications between the first agent device and the second agent device in a second panel of the user interface.

17. The system of claim 11, wherein the plurality of instructions further causes the system to provide a user interface with one or more user interface elements to search for the second agent prior to establishing communication between the first agent device and the second agent device.

18. The system of claim 11, wherein the plurality of instructions further causes the system to provide a request from the first agent device to the second agent device to establish communication via the internal communication channel; and
wherein to establish communication via the internal communication channel comprises to establish communication between the first agent device and the second agent device via the internal communication channel in response to receipt of an acceptance of the request.

19. The system of claim 11, wherein the plurality of instructions further causes the system to provide one or more communications from the second agent device to the customer device via the initial communication channel after establishing communication between the first agent device and the second agent device via the internal communication channel.

20. The system of claim 19, wherein the plurality of instructions further causes the system to transfer the communication session from the first agent device to the second agent device.
